(19) United States
(12) Patent Application Publication
(10) Pub. No.: US 2006/0285716 A1
(43) Pub. Date: Dec. 21, 2006

(54) Wire management system

(75) Inventor: Ryan Lee Gordon, San Marcos, CA (US)

Correspondence Address: ROBERT D. FISH;RUTAN & TUCKER LLP, 611 ANTON BLVD 14TH FLOOR, COSTA MESA, CA, 92626-1931, US

(73) Assignee: Dana Innovations

(21) Appl. No.: 11/387,022

(22) Filed: Mar. 21, 2006

Related U.S. Application Data
(60) Provisional application No. 60/691,508, filed on Jun. 16, 2005.

(51) Int. Cl. H04R 1/02

(52) U.S. Cl. 381/386

(57) ABSTRACT

An improved wire connection system and method is provided. More specifically, an improved wire connection system for audio systems and method that employs a wire connection and/or terminal may be positioned on the front portion of a speaker housing unit. The wire connection system and method allows for positioned of the wire connection and/or terminal on the front portion of the speaker housing unit while allowing the incoming wiring from the transmitting unit to be hidden behind the speaker housing, passed through an opening contained within the housing and connected to at the front portion of the speaker housing to facilitate easier connection of the speaker to the transmitting unit.

### PRIORITY DATA

This application is filed claiming priority to the earlier filed provisional application filed Jun. 16, 2005.

### FIELD OF THE INVENTION

This invention relates to the field of a audio systems. More specifically, this invention relates to a system and a method for securing and connecting audio equipment to a power and transmitter source. Further, this invention relates to a system for a more effective and efficient system of connecting audio equipment to a transmitting source.

### BACKGROUND OF THE INVENTION

Home audio systems are becoming a very popular necessity in today's entertainment crazed society. Having a great visual system such as large screen TVs, plasmas and the like can provide great home viewing of entertainment programming, sporting events and movies, which traditionally could only be viewed at entertainment outposts such as movie theatres. However, a lack of good sound quality usually made the home viewing experience inferior to the experience one would find at a movie theatre, or the sound quality one would find at an entertainment venue accustomed to good sound.

The solution to this problem came in the form of good residential and/or commercial audio systems which could be analogous to larger entertainment venue audio systems. As the audio systems improved, it became necessary to simulate as close as possible true surround sound of the audio sounds which gave rise to surround sound systems which employed a plurality of different speakers which controlled different sounds to be projected to the end user to similate this sensation of surround sound. However, it was necessary to employ speaker wire to connect the surround sound speaker to the transmitter. These speaker wires could be intrusive and have the ability to visual detract from the aesthetics of both the speaker and the whole room, and bring visual notice to the wiring necessary to connect the speaker to the transmitting unit.

In an effort to eliminate this aesthetic defect, existing speaker housings typically have terminals on the back of the housing unit to connect the speaker housing to the transmitter unit. Additionally, some existing speaker housings may have side mounted terminals such that the wiring may be easier to get to if a speaker is mounted to a wall. However, a problem with these side mounted and rear mounted terminals on the existing speaker housings, is that they pose time consuming installation disadvantages. These speaker housings require the user to move the speaker away from any wall or surrounding structures to connect the speaker wires for further connection to the transmitting unit. The need to remove the speaker housing from the wall or a support structure can take considerable time and may cause unnecessary damage to flooring and shelving. Consequently, the need for improved audio experience can be frustrating and costly to the end user.

A need therefore exists for an improved wiring solution for speaker housings that may make facilitate the connection of the speaker housing to the transmitting unit much easier and efficient.

Further, a need exists for an improved wiring solution for speaker housings that may allow a user to install speaker wiring to the speaker housing without the necessity of displacing the speaker from its support structure including a wall or a speaker stand.

### SUMMARY OF THE INVENTION

The present invention provides an improved wire connection system and method. More specifically, the present invention provides a improved wire connection system and method that employs a terminal position on the front portion of the speaker housing unit. Additionally, the present invention also provides an improved wire connection system and method that employs a terminal position on the front portion of the speaker housing unit while allowing the wire to be hidden behind the speaker housing, passed through an opening in the housing and connected to at the front portion of the housing to facilitate easier connection of the speaker to the transmitting unit.

To this end, in an embodiment of the present invention, an audio system is provided. The audio system has a speaker housing having a front portion, back portion, bottom portion and top portion. Additionally, the audio system has a speaker housing having at least a side portion. The system further has a speaker contained within the speaker housing wherein the speaker projects sound outward from the speaker housing and a wire connector on the front portion of the speaker housing for input of speaker wires to connect the speaker to the transmitting unit.

In an embodiment, the audio system has a plurality of wire connectors on the front portion of the speaker housing for input of wires to connect the speaker to the transmitting unit.

In an embodiment, the audio system has at least one transducer which is coupled to the front portion of the speaker housing.

In an embodiment, the audio system has a plurality of transducers configured on the front portion of the speaker housing.

In an embodiment, the audio system has a tubular enclosure positioned between the front portion of the speaker housing and the rear portion of the speaker housing.

In an embodiment, the audio system has a tubular enclosure positioned within the speaker housing to allow for penetration of wires from the rear portion of the speaker housing to the front portion of the speaker housing.

In an embodiment, the audio system has a tubular enclosure positioned within the speaker housing wherein the tubular enclosure has at least one gate at an outside edge of the tubular enclosure such that the gate is moveable about the outside edge of the tubular enclosure.

In an embodiment, the audio system has a tubular enclosure that is configured in any geometric shape that permits the penetration of a wire therethrough.

In another embodiment of the present invention, an electric housing is provided. The electric housing has a housing having a front portion, back portion, bottom portion and top portion. Moreover, the housing has at least a side portion and a speaker contained within the housing wherein the speaker projects sound outward from the speaker housing. Additionally, the housing has a tubular enclosed passage connecting the front portion of the housing with the rear portion of the housing.

In an embodiment, the audio system has a housing coupled to at least a transducer.

In an embodiment, the audio system has a housing coupled to a plurality of transducers.

In an embodiment, the audio system has a wire connector on the front portion of the housing for input of speaker wires to connect a speaker to the transmitting unit.

In an embodiment, the audio system has a housing coupled with electronic circuitry for amplifying an audio signal.

In an embodiment, the audio system has a housing coupled with electronic circuitry for decoding an audio signal.

In an embodiment, the audio system has a housing that is a flat panel.

In an embodiment, the audio system has a tubular enclosure having a gate positioned at the outside edge of the tubular enclosure which may be opened and closed which in turn opens and closes the tubular enclosure at the front portion of the housing and the rear portion of the housing.

In another embodiment of the present invention, a method for using an audio system is provided. The method comprising the steps of: providing a speaker housing having a front portion, back portion, bottom portion and top portion; providing said speaker housing with at least a side portion; coupling a speaker with the speaker housing wherein the speaker projects sound outward from the speaker housing; and positioning a wire connector on the front portion of the speaker housing for input of speaker wires to connect the speaker to the transmitting unit.

In an embodiment, the method further comprises the step of: providing a tubular enclosure positioned within the speaker housing between the front portion and the rear portion of the housing.

In an embodiment, the method further comprises the step of: attaching said speaker housing to a support structure.

In an embodiment, the method further comprises the step of: adapting a wire from a support structure, inserting the wire into the tubular enclosure on the rear portion of the speaker housing and extending the wire outwardly through the front portion of the speaker housing.

In an embodiment, the method further comprises the step of: attaching a wire to the wire connectors located on the front portion of the speaker housing.

In an embodiment, the method further comprises the step of: attaching a speaker cover to the front portion of the speaker housing such that the wire connector and tubular enclosure are not visible at the front portion of the speaker housing.

It is, therefore, an advantage of the present invention to provide an improved wiring system and method for using the same.

Another exemplary embodiment of the present invention is to provide an improved wiring system and method for using the same wherein the use of the system and method facilitates easier wiring of the speaker to the transmitting unit.

Yet another exemplary embodiment of the present invention is to provide an improved wiring system and method for using the same wherein the improved wiring system may eliminate scratching and/or damage of the speaker housing units with employment of the wiring system.

Still another exemplary embodiment of the present invention is to provide an improved wiring system and method for using the same wherein the improved wiring system may eliminate the need to disconnect the speaker housing from its support structure.

Another exemplary embodiment of the present invention is to provide an improved wiring system and method for using the same wherein the speaker housing may be mounted to a wall and/or support structure prior to wiring the speaker housing to the transmitting unit.

Yet another exemplary embodiment of the present invention is to provide an improved wiring system and method for using the same wherein the connection terminal for the wiring may be positioned on the front portion of the speaker housing unit.

Still another exemplary embodiment of the present invention is to provide an improved wiring system and method for using the same wherein the connection terminal for the wiring may be positioned on the front portion of the speaker housing unit and further wherein the connection terminal may be recessed on the front portion of the speaker housing and further wherein the connection terminal may be covered such that the wiring and the terminal are obstructed from view.

Another exemplary embodiment of the present invention is to provide an improved wiring system and method for using the same wherein the system may use a traditional housing unit wherein the speaker projects sound in the forward direction, yet still allows for adequate space for terminal connection of the speaker housing to the transmitting unit.

Yet another exemplary embodiment of the present invention is to provide an improved wiring system and method for using the same wherein the housing mounts a transducer to produce sound in the front direction.

Still another exemplary embodiment of the present invention is to provide an improved wiring system and method for using the same wherein the speaker housing may have a tubular enclosed passage connecting the front portion of the speaker housing to back portion of the speaker housing.

Another exemplary embodiment of the present invention is to provide an improved wiring system and method for using the same wherein the speaker housing may have a tubular enclosed passage which may connect the front portion of the speaker housing with the back portion of the speaker housing and further wherein the tubular enclosure may have gates positioned thereon for opening and closing of the tubular passage.

Yet another exemplary embodiment of the present invention is to provide an improved wiring system and method for using the same wherein the system may have an electronic chassis that may have a tubular passage which may connect the front portion of the speaker housing with the back portion of the speaker housing.

Still another exemplary embodiment of the present invention is to provide an improved wiring system and method for using the same wherein the system may have an electronic chassis that may have a tubular passage which may connect the front portion of the speaker housing with the back portion of the speaker housing and further wherein the tubular enclosure may have gates positioned thereon for opening and closing of the tubular passage.

Another exemplary embodiment of the present invention is to provide an improved wiring system and method for using the same wherein the system may have a tubular passage wherein the tubular passage may be located near the bottom portion of the speaker housing to facilitate easier connection of speaker wire that my be adapted from a speaker structural support member.

Yet another exemplary embodiment of the present invention is to provide an improved wiring system and method for using the same wherein the tubular passageway may be configured in a plurality of geometric shapes including oval, trapezoidal, rectangular, triangular and/or in any shape adapted for use with allowing for wiring to be accessed from the back portion of the speaker housing to the front portion of the speaker housing.

Still another exemplary embodiment of the present invention is to provide an improved wiring system and method for using the same wherein the system may facilitate easier connection of the speaker housing to the transmitting unit.

An exemplary embodiment of the present invention is to provide an improved wiring system and method for using the same wherein the system may facilitate connection of the speaker housing to the transmitting unit without the need to remove the speaker from a support structure.

Yet another exemplary embodiment of the present invention is to provide an improved wiring system and method for using the same wherein the system may have a tubular enclosure wherein the tubular enclosure may be positioned anywhere on the speaker housing including the top portion, the bottom portion and the side portions as long as the tubular enclosure allows for connection of the front portion of the speaker housing with the back portion of the speaker housing.

Still another exemplary embodiment of the present invention is to provide an improved wiring system and method for using the same wherein the system may employ connections on the front side of the housing.

Another exemplary embodiment of the present invention is to provide an improved wiring system and method for using the same wherein the system may allow easier access from a bracket or support housing to the connection terminal of the speaker housing.

Another exemplary embodiment of the present invention is to provide an improved wiring system and method for using the same wherein the connection terminal may have a protective gate to protect the wiring and the terminal once wiring has been configured to connect the speaker to the transmitting unit.

These and other objects of the invention will become more clear when one reads the following specification, taken together with the drawings that are attached hereto. The scope of protection sought by the inventors may be gleaned from a fair reading of the Claims that conclude this specification.

Additional features and advantages of the present invention are described in, and will be apparent from, the detailed description of the presently preferred embodiments and from the drawings.

### DESCRIPTION OF THE DRAWINGS

FIG. 1 is a front view of the speaker housing in an exemplary embodiment of the present invention;

FIG. 2 is a perspective view of the speaker housing illustrating the connectors in an exemplary embodiment of the present invention;

FIG. 3 is a side cross-sectional view of the speaker housing in an exemplary embodiment of the present invention;

FIG. 4 is a back view of the speaker housing in an exemplary embodiment of the present invention;

FIG. 5 is a bottom view of the speaker housing in an exemplary embodiment of the present invention;

### DESCRIPTION OF THE PREFERRED EMBODIMENT

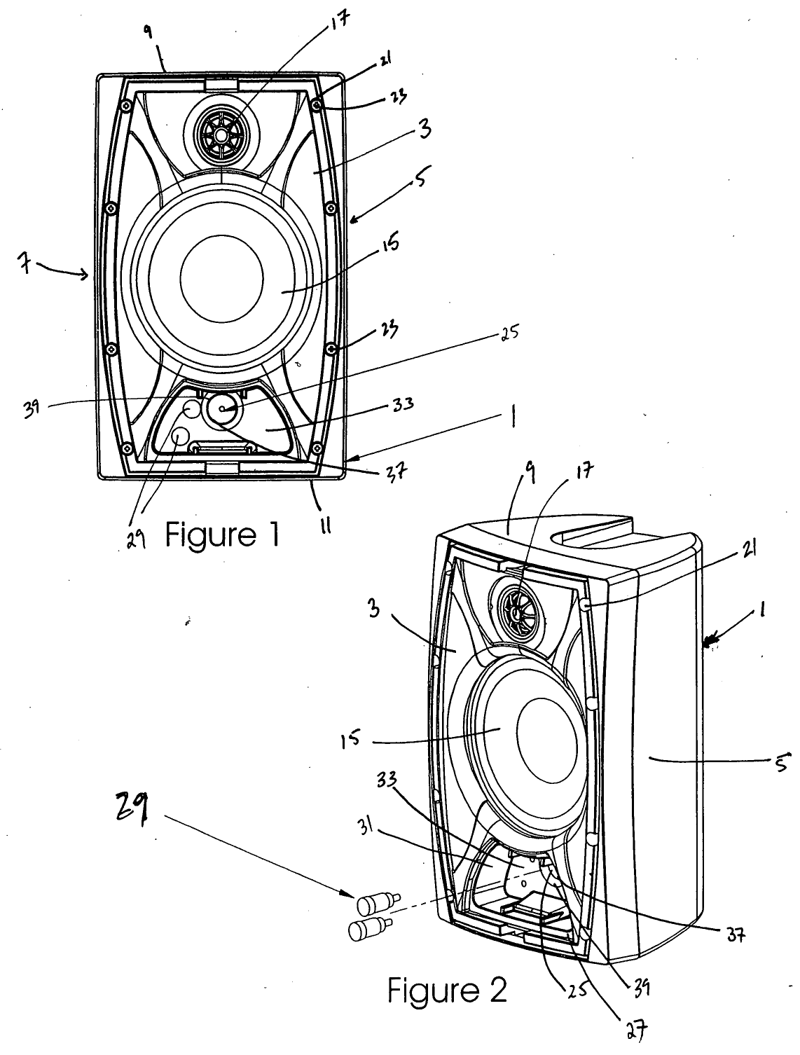

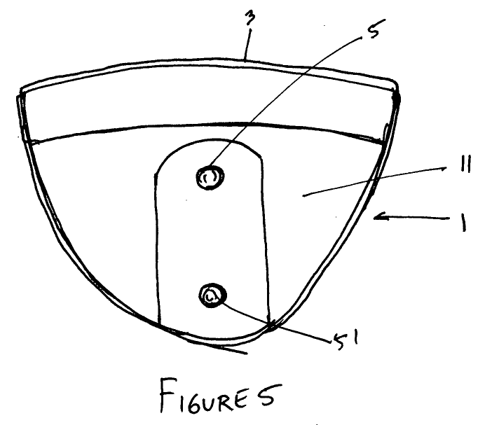

Turning now to the drawings wherein elements are identified by numbers and like elements are identified by like numbers throughout the 5 figures, the invention is depicted in FIG. 1 that illustrates a speaker housing 1 for use in the unique wiring system. As shown in FIGS. 1 and 2, the speaker housing 1 may have a plurality of sides including a front portion 3, a first side portion 5, a second side portion 7, a top portion 9 and a bottom portion 11. Additionally, a back portion 13 is illustrated in FIG. 4. As FIG. 1 further illustrates, the front portion 3 exemplifies the majority of the hardware contained within the speaker housing 1. The speaker housing 1 may contain the speaker 15 which may have a directional setting projecting sound out of the front portion 3 of the speaker housing 1. In other exemplary embodiments, the speaker 15 may face rearwardly, projecting sound out of the rear portion 13 of the speaker housing 1. Moreover, it is anticipated that the speaker 15 may be positioned anywhere within the speaker housing and may project sound from that location. In an exemplary embodiment illustrated in FIG. 1, the speaker 15 is contained within the speaker housing 1 and projects through the front portion 3 of the housing 1. Additionally as exemplified, the front portion may also have a tweeter 17 and/or additional smaller speaker contained thereon wherein the tweeter 17 and/or additional smaller speaker may also project sound through the front portion 3 of the speaker housing 1. In an embodiment, a plurality of tweeters 17 may be adapted for use in a single speaker housing 1. Moreover, in an embodiment, a plurality of speakers 15 may be adapted for use in a single speaker housing 1. The speaker housing 1 may also allow for configuration of the speaker 15 therein by allowing for replacement of the speaker 15 when necessary by providing a plurality of connection points 21 that may be in the form of a screw 23. When the screws 23 are removed, the speaker 15 may be detachably removed from the speaker housing 1 which may allow for interchangeability of the speaker 15 relative to the speaker housing 1. FIG. 1 further illustrates the tubular enclosure 25 in the front portion 3 of the speaker housing 1. The tubular enclosure 25 extends rearwardly from the front portion 3 of the speaker housing 1 to the rear portion 13 of the speaker housing as illustrated in FIG. 4.

FIG. 2 further illustrates the tubular enclosure 25 that extends between the front portion 3 of the speaker housing 1 and the rear portion 13 of the speaker housing 1. As illustrated in FIG. 2, the tubular enclosure 25 may be recessed within a recessed portion 31 from the outside edge 27 of the front portion 3. Providing the enclosure 25 recessed from the outside edge 27 of the front portion 3 may allow for adequate space between the outside edge 27 of the front portion 3 and the tubular enclosure 25 to facilitate storage of the wiring apparatus (not shown) within the recessed portion 31 of the speaker housing 1. FIGS. 1 and 2 illustrate wire connectors 29 positioned on the front portion 3 of the speaker housing 1. In prior art applications, the wire connectors are typically positioned in the rear of the speaker housing which makes getting to those connectors rather difficult and cumbersome. In an exemplary embodiment of the present invention, the wire connectors 29 are position within the recessed portion 31 of the speaker housing, which allows a wire apparatus (not shown) to pass through the tubular enclosure 25 from the rear portion 13 of the speaker housing 1 to the front portion 3 of the speaker housing and connected to the wire connectors 29 positioned on the outside surface 33 of the recessed portion 31 of the speaker housing 1.

The tubular enclosure 25 in an exemplary embodiment may be positioned below the speaker 15 in a location within the speaker housing 1 that may facilitate easier and more efficient connection of the wire apparatus to the wire connectors 29. In an embodiment, the tubular enclosure 25 may be of generally tubular shape, but it should be anticipated that the tubular enclosure 25 may be of any shape to facilitate the insertion of a wire apparatus (not shown) from the rear portion 13 of the speaker housing 1 to the front portion 3 of the speaker housing 1. The configuration of the tubular enclosure is not limited to a generally tubular shape, but can include a plurality of different shapes including rectangular, trapezoidal, oval, triangular and a variety of other geometric shapes.

Additionally, the tubular enclosure 25 may also have a first gate 37 positioned at the outside edge 39 of the front portion of the tubular enclosure 25. Moreover, the tubular enclosure 25 may also have a second gate 41 positioned at the outside edge 44 of the back portion of the tubular enclosure 25. The first gate 37 and the second gate 41 (see FIG. 4) may allow for opening and closing of the tubular enclosure 25 when the enclosure 25 is not in use. Additionally, the first gate 37 and the second gate 41 may have an opening 45 (see FIG. 4) thereon to allow only the wire apparatus (not shown) to pass through the tubular enclosure 25. (See FIG. 4).

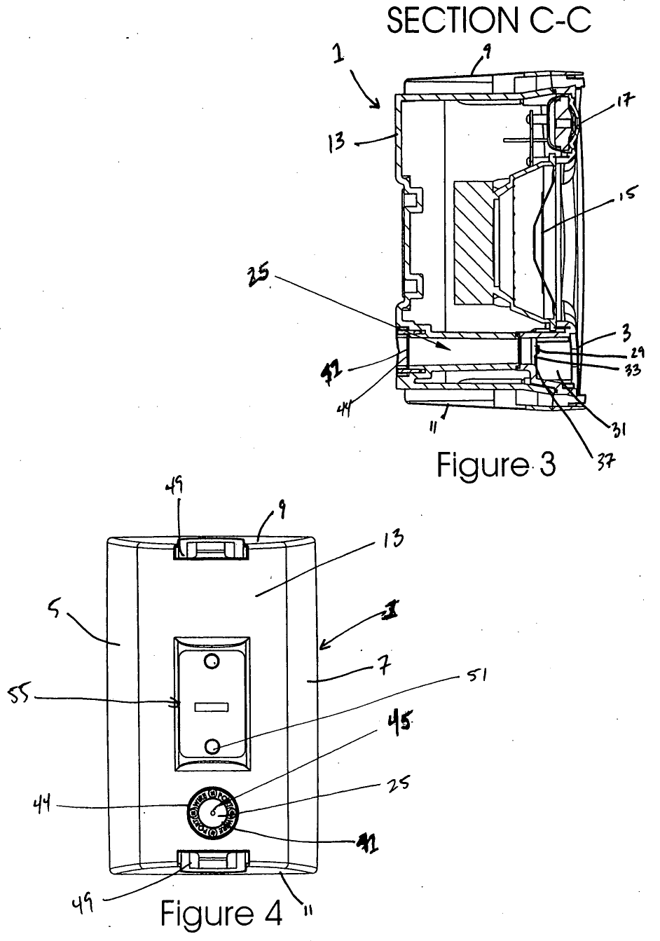

FIG. 3 illustrates a cross sectional view of the speaker housing 1 wherein the tubular enclosure 25 extends from the rear portion 13 of the speaker housing 1 to the front portion 3 of the speaker housing 1. Additionally, FIG. 3 illustrates the speaker housing 1 incorporation of the speaker 15 and the tweeter 17 and/or additional speakers. Moreover, FIG. 3 illustrates the wire connectors 29 positioned on the outside edge 33 of the recessed portion 31. As illustrated in FIG. 3, a wire apparatus (not shown) may enter into the tubular enclosure 25 of the speaker housing 1 from the rear portion 13. The speaker housing 1 may be positioned on a wall and/or a support structure (not shown) to suspend the speaker housing 1 therefrom. Allowing the wire apparatus to enter from the rear, be navigated through the tubular enclosure 25 and extend outwardly from the front portion 3 of the speaker house 1 and ultimately attached to the wire connectors 29 on the front portion 3 would allow the individual responsible for connecting the speaker to the transmission unit (not shown) to do so with relative ease without the need to remove the speaker housing 1 from its support structure.

FIG. 4 illustrates a back view of the speaker housing 1 in an embodiment. The back portion 13 may have the tubular enclosure 25 along with the gate 41 including the opening 45 thereon to allow for insertion of the wire apparatus through the enclosure 25. In an embodiment, speaker housing 1 may have a mounting bracket (not shown) attached to a corresponding attachment point 49. The attachment point 49 may be located on the top portion 9 and the corresponding bottom portion 11 of the speaker housing 1. However, it is anticipated that the speaker housing may have a standard attachment aperture 51 thereon. In an exemplary embodiment, the standard attachment aperture 51 may be located at the mid point 55 of the back portion 13 of the speaker housing 1. However, in another embodiment, the attachment aperture 51 may be located at any other position on the back portion 13 of the speaker housing 1 to allow for attachment of the speaker housing 1 to a support structure (not shown). Additionally, as illustrated in FIG. 5, the attachment aperture 51 may be located on the bottom portion 11 of the housing 1 to allow for attachment of the speaker housing 1 to a support structure. In another exemplary embodiment, a plurality of attachment apertures 51 may be located at different locations on the speaker housing to allow for multiple configurations and attachment points for different types of support structures having different configurations.

It should be understood that various changes and modifications to the presently preferred embodiments described herein will be apparent to those skilled in the art. Such changes and modifications may be made without departing from the spirit and scope of the present invention and without diminishing its attendant advantages.

What is claimed is:

1. An audio system comprising:
a speaker housing having a front portion, back portion, bottom portion and top portion;
said speaker housing having at least a side portion;
a speaker contained within the speaker housing wherein the speaker projects sound outward from the speaker housing; and
a wire connector on the front portion of the speaker housing for input of speaker wires to connect the speaker to the transmitting unit.

2. The audio system of claim 1, further comprising:
a plurality of wire connectors on the front portion of the speaker housing for input of wires to connect the speaker to the transmitting unit.

3. The audio system of claim 1, further comprising:
at least one transducer which is coupled to the front portion of the speaker housing.

4. The audio system of claim 1 further comprising:
a plurality of transducers configured on the front portion of the speaker housing.

5. The audio system of claim 1 further comprising:
a tubular enclosure positioned between the front portion of the speaker housing and the rear portion of the speaker housing.

6. The audio system of claim 1 further comprising:
a tubular enclosure positioned within the speaker housing to allow for penetration of wires from the rear portion of the speaker housing to the front portion of the speaker housing.

7. The audio system of claim 1 further comprising:
a tubular enclosure positioned within the speaker housing wherein the tubular enclosure has at least one gate at an outside edge of the tubular enclosure such that the gate is moveable about the outside edge of the tubular enclosure.

8. The audio system of claim 6 wherein the tubular enclosure is configured in any geometric shape that permits the penetration of a wire therethrough.

9. An electric housing comprising:
a housing having a front portion, back portion, bottom portion and top portion;
said housing having at least a side portion;
a speaker contained within the housing wherein the speaker projects sound outward from the speaker housing; and
a tubular enclosed passage connecting the front portion of the housing with the rear portion of the housing.

10. The electric housing of claim 9 further comprising:
said housing coupled to at least a transducer.

11. The electric housing of claim 9 further comprising:
said housing coupled to a plurality of transducers.

12. The electric housing of claim 9 further comprising:
a wire connector on the front portion of the housing for input of speaker wires to connect a speaker to the transmitting unit.

13. The electric housing of claim 9 further comprising:
the housing coupled with electronic circuitry for amplifying an audio signal.

14. The electric housing of claim 9 further comprising:
the housing coupled with electronic circuitry for decoding an audio signal.

15. The electric housing of claim 9 wherein the housing is a flat panel.

16. The electric housing of claim 9 wherein said tubular enclosure has a gate positioned at the outside edge of the tubular enclosure which may be opened and closed which in turn opens and closes the tubular enclosure at the front portion of the housing and the rear portion of the housing.

17. A method for using an audio system assembly, the method comprising the steps of:
providing a speaker housing having a front portion, back portion, bottom portion and top portion;
providing said speaker housing with at least a side portion;
coupling a speaker with the speaker housing wherein the speaker projects sound outward from the speaker housing; and
positioning a wire connector on the front portion of the speaker housing for input of speaker wires to connect the speaker to the transmitting unit.

18. The method of claim 17 further comprising the step of:
providing a tubular enclosure positioned within the speaker housing between the front portion and the rear portion of the housing.

19. The method of claim 17 further comprising the step of:
attaching said speaker housing to a support structure.

20. The method of claim 17 further comprising the step of:
adapting a wire from a support structure, inserting the wire into the tubular enclosure on the rear portion of the speaker housing and extending the wire outwardly through the front portion of the speaker housing.

21. The method of claim 17 further comprising the step of:
attaching a wire to the wire connectors located on the front portion of the speaker housing.

22. The method of claim 17 further comprising the step of:
attaching a speaker cover to the front portion of the speaker housing such that the wire connector and tubular enclosure are not visible at the front portion of the speaker housing.
